(19) United States
(12) Patent Application Publication
(10) Pub. No.: US 2004/0034709 A1
(43) Pub. Date: Feb. 19, 2004

(54) Information providing system and method using wireless internet

(75) Inventor: Ja-Youn Lee, Seoul (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 10/376,221

(22) Filed: Feb. 27, 2003

(30) Foreign Application Priority Data
Aug. 16, 2002 (KR) 2002-48459

(51) Int. Cl. G06F 15/16

(52) U.S. Cl. 709/228; 709/218; 709/230

(57) ABSTRACT

Disclosed is an information providing system and method that provides information desired by a user in real time through a mobile communication terminal. The mobile communication terminal sets in advance receiving times for the respective information, and requests the information by accessing a contents provider server at the respective receiving times. The system includes a contents provider server for receiving and storing information to be provided to a user through a wire network and at least one mobile communication terminal for storing the information requested by the user and associated receiving times, wherein the contents provider server searches in real time for requested information in response to an information request from a mobile communication terminal, and provides the found information to the mobile communication terminal through a mobile communication network. The mobile communication terminal requests the information having corresponding receiving times by accessing the contents provider server through the mobile communication network at the respective receiving times, and receives and outputs the information searched in real time by the contents provider server.

### PRIORITY

This application claims priority to an application entitled “Information Providing System and Method Using Wireless Internet” filed in the Korean Industrial Property Office on Aug. 16, 2002 and assigned Serial No. 2002-48459, the contents of which are hereby incorporated by reference.

### BACKGROUND OF THE INVENTION

1. Field of the Invention

The present invention relates to an information providing system, and more particularly to an information providing system and method for providing information to a user using wireless Internet.

2. Description of the Related Art

With the rapid development of the communication industry and the rapid expansion of the mobile communication service, mobile communication terminals have almost become requisites for daily living. Such mobile communication terminals have additional functions such as memos, schedule management, electronic calculators, alarm function, etc., besides calling and text message transmitting/receiving functions. Recently, to meet users' diverse needs, diverse additional functions such as MP3, wireless Internet, camera, television (TV) function, etc., have been added to mobile communication terminals. To cope with such needs, mobile communication providers provide diverse services such as loaming services, information services, etc., to the users.

The information service provided by the mobile communication provider is classified into a text data service and a voice data service. In order to receive such text and voice data services, the user accesses a contents provider (CP) server that provides information using the wireless access to the Internet, and after performing a user registration, the user selects the information that the user desires to receive. The contents provider server that stores user data performs a user authentication, and provides the information selected by the user. In the same manner, the user can be provided with e-mail service, weather forecast service, traffic information service, news service, fortune-telling service, performer's voice mail service, morning call service, etc.

However, in order to provide the information to the user in the above-described manner, the contents provider server needs to check a large amount of user data in real time. Also, an information menu needs to be provided whenever the mobile communication terminal accesses the server. This may cause a system overload, and the user may feel inconvenienced since he/she must select from the provided information menu every time. Due to the time delay caused by the providing and selecting of the information menu, a relatively high cost for the information service is incurred.

### SUMMARY OF THE INVENTION

Accordingly, the present invention has been made to solve the above-mentioned problems in the prior art, and an object of the present invention is to provide an information providing system and method that provides information desired by a user in real time by a mobile communication terminal, which accesses a contents provider server at a time predetermined by the user and requests the information.

In order to accomplish this object, there is provided an information providing system using a wireless access to the Internet, comprising: a contents provider server for receiving and storing information to be provided to a user through a wire network; and at least one mobile communication terminal for storing the information requested by the user and receiving times for the respective information, wherein the contents provider server searches in real time for requested information in response to an information request from a mobile communication terminal, and provides the found information to the mobile communication terminal through a mobile communication network, and the mobile communication terminal requests the information requested by the user corresponding to the respective receiving times by accessing the contents provider server through the mobile communication network at the respective receiving times, and receives and outputs the information searched in real time by the contents provider server.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram of an information providing system according to an embodiment of the present invention;

FIG. 2 is a block diagram of a mobile communication terminal according to an embodiment of the present invention;

FIG. 3 is a block diagram of a contents provider server according to an embodiment of the present invention; and

FIG. 4 is a flowchart illustrating an information providing method according to an embodiment of the present invention.

### DETAILED DESCRIPTION OF THE PREFERRED EMBODIMENT

Hereinafter, the information providing system and method according to a preferred embodiment of the present invention will be described with reference to the accompanying drawings. In the following description of the present invention, a detailed description of known functions and configurations incorporated herein will be omitted when it may make the subject matter of the present invention rather unclear.

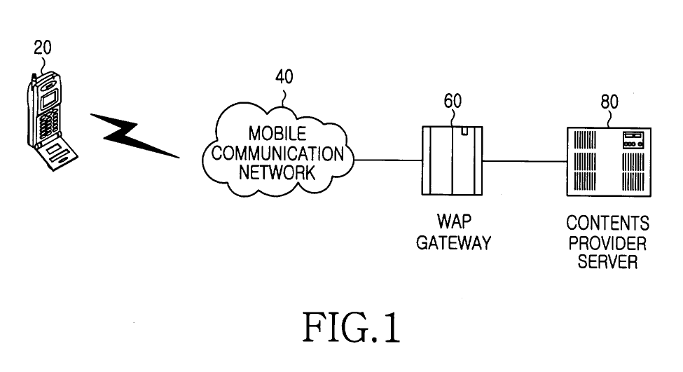

FIG. 1 is a block diagram of an information providing system according to an embodiment of the present invention.

Referring to FIG. 1, the information providing system includes a mobile communication terminal 20, a mobile communication network 40, a wireless application protocol (WAP) gateway 60, and a contents provider server 80. The information providing system as constructed above is based on a WAP type wireless Internet, but it may be constructed based on a mobile explorer (ME) type wireless Internet that does not require the WAP gateway.

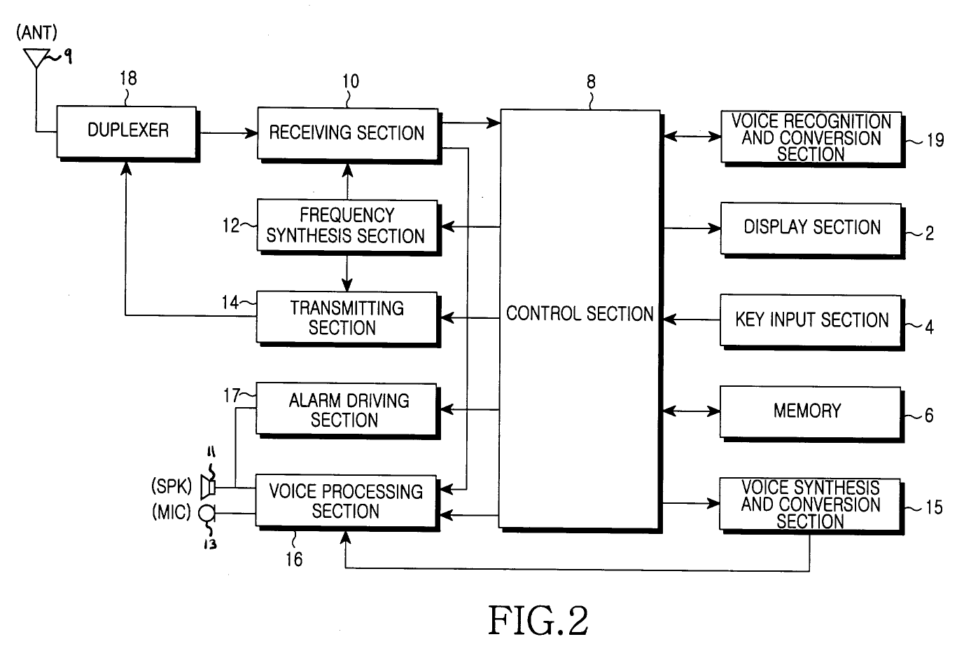

The mobile communication network 40 includes a mobile switching center (MSC), a base station controller (BSC), and a base transceiver system (BTS). The WAP gateway 60 provided between the mobile communication network 40 and the contents provider server 80 serves as an interface between the wire Internet and the wireless Internet, that is, the mobile communication network 40 and the contents provider server 80. The mobile communication terminal 20 accesses the contents provider server 80 through the mobile communication network 40, and receives the information requested by the user. The construction and operation of the mobile communication terminal will be explained with reference to FIG. 2, which illustrates a mobile communication terminal according to an embodiment of the present invention.

A key input section 4 of the mobile communication terminal 20 is provided with a plurality of numeral keys and character keys, and if the user presses a specified key, it generates and outputs corresponding key data to a control section 8. A duplexer 18 extracts a specified band signal from signals received through an antenna ANT 9 to output the extracted signal to a receiving section 10, and outputs the signal received from a transmitting section 14 to the antenna 9. The transmitting section 14 converts a voice signal outputted from a voice processing section 16 into a signal of a transmission band using a signal received from a frequency synthesizing section 12, and outputs the converted signal to the duplexer 18. The receiving section 10 outputs to the voice processing section 16 the voice signal separated from the signals received under the control of the control section 8, and outputs the signals except for the voice signal to the control section 8. The frequency synthesizing section 12 generates and outputs a frequency signal to be outputted to the transmitting section 14 and the receiving section 10 under the control of the control section 8. The voice processing section 16 converts the signal received from the receiving section 10 into an electric voice signal by decoding to the received signal, and outputs the electric voice signal to a speaker SPK 11. Then, the speaker SPK 11 converts the received electric voice signal into an audible sound to output the audible sound. Also, a microphone MIC 13 converts an audible frequency signal into an electric voice signal to output the voice signal to the voice processing section 16. Then, the voice processing section 16 encodes the received electric voice signal, and outputs the encoded voice signal to the transmitting section 14.

A display section 2 displays a state and an operational process of the mobile communication terminal 20. In one embodiment of the present invention, the display section 2 also provides to the user a menu of information to be received that the user intends to receive, and displays text data among information received from the contents provider server 80.

An alarm driving section 17 drives an alarm for informing reception of the information from the contents provider server 80. Different alarm sounds are outputted from the alarm driving section 17 in accordance with the kinds of received information.

A voice synthesis and conversion section 15 converts the text data received from the contents provider server 80 into voice data, and outputs the converted voice data to the voice processing section 16. A voice recognition and conversion section 19 converts the voice data received from the contents provider server 80 into text data to output the converted text data.

A memory 6 temporarily stores a driving program required for the control operation of the control section 8 and data generated during the control operation. The memory 6 stores a received information table representing the information that the user desires to receive, i.e., the information requested by the user, and receiving times for the respective information. The received information table may be constructed as Table 1 below.

TABLE 1

| Received Information | Receiving Time |
|---|---|
| Alarm | 06:00 |
| Weather | 06:30 |
| News | 07:00 |
| Traffic | 07:30 |
| Mail | 12:30 |
| Sports | 20:00 |

The control section 8 controls the operation of the mobile communication terminal 20. In one embodiment of the present invention, the control section accesses the contents provider server 80 at the predetermined receiving time based on the received information table stored in the memory 6, requests the information corresponding to the receiving time, and receives the information. The control section 8 also controls the alarm driving section 17 to drive the alarm for informing that the information is received from the contents provider server 80. The control section 8 also controls the voice synthesis and conversion section 15 to convert the text data among the information received from the contents provider server 80 into the voice data, and controls the voice recognition and conversion section 19 to convert the voice data among the received information into the text data. When the information is received, the control section controls them to output both the voice data and the text data.

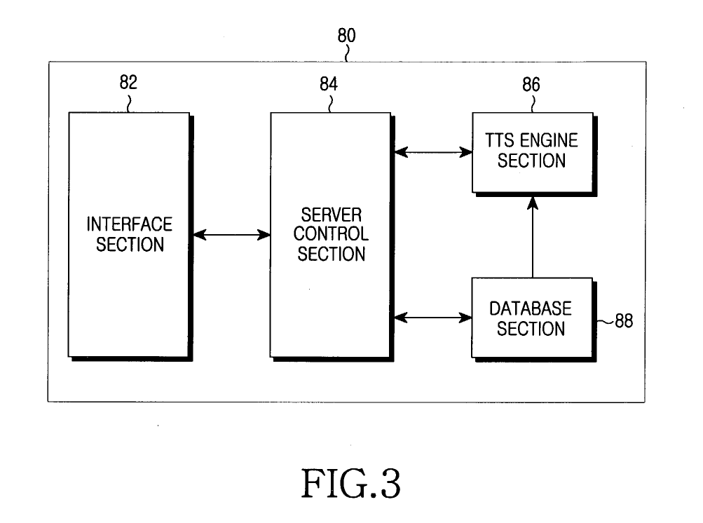

Meanwhile, the contents provider server 80 that provides the information to the mobile communication terminal 20 is connected to a wire network (not illustrated) to receive and store various kinds of information requested by the user. The construction and operation of the contents provider server 80 will be explained with reference to FIG. 3, which illustrates a contents provider server according to an embodiment of the present invention. First, an interface section 82 serves as an interface with the WAP gateway 60. A database section 88 stores user data and information requested by the user, for example, text data and voice data received from the wire network. The text data and the voice data may be information on the alarm, weather, news, traffic, mail, sports, etc. A text-to-speech (TTS) engine section 86 that performs a similar function to the voice synthesis and conversion section 15 of the mobile communication terminal 20 converts the text data among the information stored in the database section 88 into the voice data under the control of a server control section 84. The server control section 84 controls the operation of the contents provider server 80. In one embodiment of the present invention, if the mobile communication terminal 20 requests the information, the server control section 84 performs the user authentication by searching in real time for the user data stored in the database section 88. Also, the server control section 84 searches for the voice and text data stored in the database section 88, and transmits the searched information to the mobile communication terminal 20 through the interface section 82. Also, if the information requested by the user is the text data, the server control section 84 controls the TTS engine section 86 to convert the text data into the voice data.

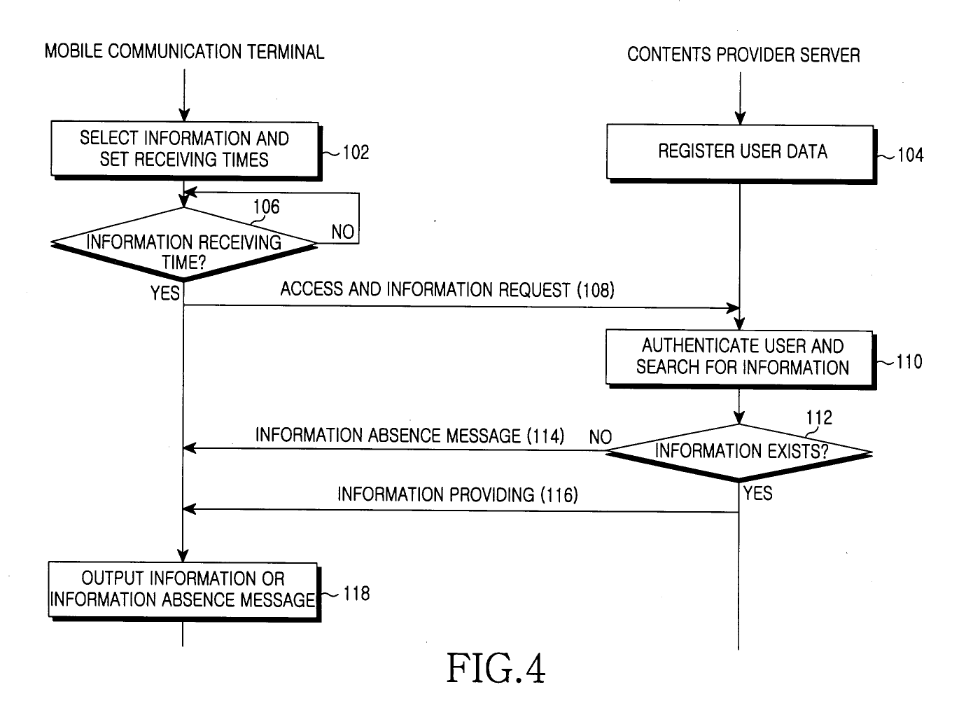

The information providing method using the wireless Internet in the information providing system as constructed above will be explained with reference to FIG. 4. FIG. 4 is a flowchart illustrating the information providing method according to the embodiment of the present invention.

First, at step 102, the information that the user desires to receive is selected, and receiving times for the respective selected information are set. Such information selection and receiving time setup are performed through a received information menu provided by the mobile communication terminal 20, and the received information menu is composed of received information and its receiving times as shown in Table 1, which is the received information table. If the user selects the received information and sets the receiving times for the received information, the mobile communication terminal 20 checks if the present time has reached the information receiving time set by the user at step 106. If the present time reaches the receiving time, the mobile communication terminal 20 attempts to access the contents provider server 80, and requests the information selected by the user, i.e., the information corresponding to the receiving time. When the mobile communication terminal 20 requests the information, the contents provider server 80 that performed in advance the user data registration of the mobile communication terminal 20 at step 104 performs the user authentication at step 110 and searches in real time for the information requested by the mobile communication terminal 20. If the information requested by the mobile communication terminal 20 does not exist at step 112, the contents provider server 80 transmits an information absence message for informing that the requested information does not exist for the mobile communication terminal 20 at step 114. If the information requested by the mobile communication terminal 20 exists, the contents provider server 80 provides the information to the mobile communication terminal 20 at step 116. At this time, if the searched information is voice data, the contents provider server 80 transmits the information to the mobile communication terminal 20 as it is, while if the searched information is text data, it converts the searched information into voice data using the TTS engine section 86, and transmits the converted voice data to the mobile communication terminal 20. The mobile communication terminal 20 receives and outputs the information transmitted by the contents provider server 80 at step 118. At this time, the mobile communication terminal 20 drives the alarm for informing that the information is received. Also, if voice data is received from the contents provider server 80, the mobile communication terminal 20 converts the voice data into text data, and outputs both the received voice data and the converted text data. If the text data is received, the mobile communication terminal 20 converts the text data into the voice data, and outputs both the received text data and the converted voice data.

Now, an information receiving method, for example, a weather information receiving method, will be explained with reference to Table 1.

First, if the user selects weather information and sets the receiving time to 6:30 a.m. as shown in Table 1, the mobile communication terminal 20 attempts the access to the contents provider server 80 at 6:30 a.m., and requests the information selected by the user, i.e., the weather information. Then, the contents provider server 80 performs the user authentication, and searches in real time for the weather information requested by the mobile communication terminal 20 in the database section 88. If the weather information searched from the database section 88 is voice data, the contents provider server 80 transmits the information to the mobile communication terminal 20 as it is, while if the found weather information is text data, it converts the found weather information into voice data using the TTS engine section 86, and transmits the converted voice data to the mobile communication terminal 20. The mobile communication terminal 20 drives the alarm for informing that the weather information has been received from the contents provider server 80, and outputs the weather information. At this time, the mobile communication terminal 20 converts the voice data into the text data, and outputs both the received voice data and the converted text data. Then, the user can listen to the weather information through the speaker SPK 11, and view the weather information through the display section 2 as well.

Meanwhile, the mobile communication terminal 20 produces different alarm sounds according to the kinds of received information so that the user can easily recognize the kind of received information.

As described above, according to the present invention, the mobile communication terminal can be provided with the requested information in real time by setting in advance the information requested by the user and receiving times for the respective information, and requesting the information by accessing the contents provider server at the respective receiving times.

By receiving in real time the requested information from the contents provider server, an overload of the contents provider server can be prevented, it is not required for the user to select the information menu every time, and the information service cost can be reduced.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. An information providing system using a wireless access to the Internet, comprising:
a contents provider server for receiving and storing information to be provided to a user; and
at least one mobile communication terminal for storing a type of information and a receiving time associated with the information, wherein the contents provider server searches in real time for requested information in response to an information request from a mobile communication terminal, and provides the information to the mobile communication terminal through a mobile communication network, and
the mobile communication terminal requests the information according to the stored receiving time by accessing the contents provider server through the mobile communication network at the receiving time, and receives and outputs the information searched in real time by the contents provider server.

2. The information providing system as claimed in claim 1, wherein the contents provider server comprises:
a database section for receiving and storing the information requested by the user through the wire network;
an interface section for performing an interface with the mobile communication terminal; and
a server control section which searches in real time for the requested information in the database section in response to the information request from the mobile communication terminal, and provides the requested information found through search to the mobile communication terminal.

3. The information providing system as claimed in claim 2, wherein the contents provider server further comprises a text-to-speech (TTS) engine section for converting text information among the information stored in the database section into voice data.

4. The information providing system as claimed in claim 1, wherein the mobile communication terminal comprises:
a display section for displaying text data among the information received from the contents provider server;
a voice processing section for converting voice data among the information received from the contents provider server into audible sounds to output converted audible sounds; and
a control section for requesting the information requested by the user by accessing the contents provider server at the respective receiving time stored in the memory, and receiving the information found through the search in real time by the contents provider server.

5. The information providing system as claimed in claim 4, wherein the mobile communication terminal further comprises an alarm driving section for informing that the requested information is received from the contents provider server.

6. The information providing system as claimed in claim 5, wherein the alarm driving section produces different alarm sounds according to a type of the received information.

7. The information providing system as claimed in claim 4, wherein the mobile communication terminal further comprises a voice synthesis and conversion section for converting the text data among the information received from the contents provider server into the voice data.

8. The information providing system as claimed in claim 4, wherein the mobile communication terminal further comprises a voice recognition and conversion section for converting the voice data from among the information received from the contents provider server into text data.

9. An information providing method using a wireless access to the Internet that is performed by a mobile communication terminal in a mobile communication system including a contents provider server for providing at least one piece of information, the method comprising the steps of:
the mobile communication terminal selecting information to be received from the contents provider server according to a user's request, and setting receiving times for the respective selected information;
if the present time reaches the receiving time, accessing the contents provider server, and requesting the information requested by the user that corresponds to the receiving time; and
receiving and outputting the information searched by the contents provider server according to the information request.

10. The information providing method as claimed in claim 9, further comprising the step of operating an alarm for informing that the requested information is received from the contents provider server.

11. The information providing method as claimed in claim 10, wherein the alarm is operated to produce different alarm sounds according to kinds of the received information.
